(19) United States
(12) Patent Application Publication
(10) Pub. No.: US 2024/0378460 A1
(43) Pub. Date: Nov. 14, 2024

(54) VARIABLE ALLOCATION DEVICE AND VARIABLE ALLOCATION METHOD

(71) Applicant: NEC Corporation, Minato-ku, Tokyo (JP)

(72) Inventor: Motoi Suzuki, Tokyo (JP)

(73) Assignee: NEC Corporation, Minato-ku, Tokyo (JP)

(21) Appl. No.: 18/689,588

(22) PCT Filed: Sep. 21, 2021
(86) PCT No.: PCT/JP2021/034586

§ 371 Date: Mar. 6, 2024

(51) Int. Cl. G06N 5/01

(52) U.S. Cl. CPC G06N 5/01

(57) ABSTRACT

The variable allocation device allocates variables of a combinatorial optimization problem to ordered multiple parallel processing means which are allocated the variables of the combinatorial optimization problem, and perform a process of obtaining values of allocated variables in parallel. The variable allocation means 71 allocates, for each of sets of variables for which a constraint is defined, variables belonging to the set to any one of the parallel processing means, and after allocating all variables to any parallel processing means, converts indices of the variables allocated to parallel processing means according to order of the parallel processing means. The matrix conversion means 72 converts a matrix used in an evaluation function of the combinatorial optimization problem according to converted indices of the variables.

### TECHNICAL FIELD

The present invention relates to a variable allocation device, a variable allocation method, and a variable allocation program that allocate variables of a combinatorial optimization problem to multiple devices that process in parallel.

### BACKGROUND ART

One statistical mechanical model for magnetic materials is the Ising model, which is formulated by Hamiltonian given by variables that take two values of 1 or -1 and their quadratic form. The Ising model describes behavior of spins of magnetic materials. The Ising model can be applied as an evaluation function in many combinatorial optimization problems. For example, by applying the quasi-annealing method to the Ising model, one can solve combinatorial optimization problems in a generic manner.

For example, PTL 1 describes an approach to solving combinatorial optimization problems in a generic manner using Ising models. Also, NPL 1 describes a specific method for formulating many kinds of combinatorial optimization problems, including number partitioning problems, graph partitioning problems, satisfiability problems, traveling salesman problems, etc., into Ising models or equivalent models.

Probability distribution of the Ising model at a given temperature T can be calculated by Markov chain Monte Carlo (MCMC) method. In Markov chain Monte Carlo method, one spin is selected, and change in Hamiltonian when changing spin state is calculated. In addition, the spin state is sampled by a dynamical system that accepts or rejects state updates according to probability according to Boltzmann weights corresponding to the temperature, with a probability distribution according to the temperature T and Hamiltonian.

The following is an example of the general Markov chain Monte Carlo method applied to an Ising model. First, notation and terminology are explained.

$$\begin{matrix}[ Math . 1 ] & \\ H ( s ) = {\sum }_{ij} {J}_{i j} {s}_{i} {s}_{j} & ( 1 )\end{matrix}$$

In expression (1), si is the i-th variable. Variables are assigned a number. This number is called an index. The subscript i represents the index. When the number of variables is N, then 1≤i≤N. In the Ising model, a value of a variable is either +1 or −1. In the field of statistical mechanics and combinatorial optimization problems, each variable is also called a spin. s is a vector with all N variables as elements. Also, Jᵢⱼ is a constant that represents coupling connecting the i-th variable to the j-th variable. The smaller the value of Jᵢⱼ, the more likely two connected variables will have the same value. It can be said that Jᵢⱼ is an element of a matrix used in the evaluation function.

In the field of optimization, Hamiltonian is called the evaluation function or the cost function. A combination of variables that minimizes the evaluation function, as expressed in expression (2), is called an optimal solution or a ground state. NPL 1 shows Hamiltonians for many optimization problems. For example, Jᵢⱼ is obtained by the method shown in NPL 1. The optimal solution is then obtained as shown in expression (2).

$$\begin{matrix}[ Math . 2 ] & \\ {s}_{min} = {arg min}_{s} H ( s ) & ( 2 )\end{matrix}$$

The objective of the Markov chain Monte Carlo method is to sample state s with a probability proportional to the probability distribution (Boltzmann distribution) expressed in expression (3) for temperature T.

$$\begin{matrix}[ Math . 3 ] & \\ π ( s ) = exp ( - \frac{H ( s )}{T} ) & ( 3 )\end{matrix}$$

The sampling operation includes the following five processes.

Process 1. Determine an initial state s randomly.

Process 2. Randomly select one of the N variables.

Process 3. s′ is the state in which the selected variable is multiplied by −1, and amount of change in the evaluation function is calculated according to expression (4).

$$\begin{matrix}[ Math . 4 ] & \\ Δ = H ( {s}^{′} ) - H ( s ) & ( 4 )\end{matrix}$$

Process 4. Determine whether to accept or reject the state transition from s to s′ with the probability given by expression (5) below, and when it is determined to accept, update state s to state s′. When the state transition is determined to be rejected, the state is retained as s.

$$\begin{matrix}[ Math . 5 ] & \\ min ( exp ( - \frac{Δ}{T} ) , 1 ) & ( 5 )\end{matrix}$$

Process 5. Repeat Processes 2 through 4.

During the above operation, the probability of occurrence of state s is guaranteed to converge to the probability distribution (expression (3)) which is the objective in the extreme limit of an infinite number of iterations.

Another commonly used model that is equivalent to expression (1) is one in which variables take the binary value of 1 or 0. To distinguish between these models, the sign s is used for variables that take the binary value of 1 or -1, and the sign x is used for variables that take the binary value of 1 or 0. In addition, the sign J is used in the matrix used in the evaluation function of the former model, and the sign Q is used in the matrix used in the evaluation function of the latter model. Both models are equivalent, and the case in which the former model (the Ising model) is used will be used as an example below.

Processes 1-5 are one example embodiment of the Markov chain Monte Carlo method with the Metropolis method. There is arbitrariness in the method of selecting the next state from the current state (equivalent to Process 2) and in the selection of the probability of accepting the update that appears in Process 4.

However, in order for the probability distribution at the convergence destination to match the probability distribution which is objective, it is necessary to define the method of selecting the next state and the acceptance probability so that the two conditions of balance and ergodicity are satisfied. In general, it is not easy to construct a dynamical system that satisfies these two conditions. A well-known method is the metropolis or heat bath method.

When the Markov chain Monte Carlo method is used, the processing time increases as the size of the target model increases. Therefore, the solution method using the Markov chain Monte Carlo method must be devised to reduce the processing time. In some cases, the processing of dynamical systems for large-scale models is performed using a large-scale computer. Even when a large computer is used, it is important to parallelize the process with high efficiency to reduce the processing time.

Literature describing techniques for parallelizing state update of dynamical systems include, for example, PTL 2 and PTL 3. The technique described in PTL 2 selects multiple variables in a process corresponding to Process 2 above and performs Processes 3-4 independently for each variable. This technique selects one of the variables accepted in Process 4 and changes the state of only the variable. Although Processes 3-4 are executed multiple times in a single iterative process, they are independent and can be parallelized.

The technique described in PTL 3 uses real values instead of discrete values for variables and performs state update based on Hamiltonian dynamics. Hamiltonian dynamics is a deterministic dynamical system that follows differential equations, unlike the Markov chain Monte Carlo method. In principle, this technique allows each variable to be updated in parallel.

The solution to a combinatorial optimization problem can also be obtained using the Markov chain Monte Carlo dynamical system. The solution of expression (2) can be obtained with a high probability when updating the dynamical system for a long time by gradually decreasing the temperature T from a high temperature, in addition to the basic operation of the Markov chain Monte Carlo method shown in Processes 1-5,

Techniques for improving the efficiency of solution search for combinatorial optimization problems are described in, for example, PTL 4.

In the technique described in PTL 4, in addition to the Hamiltonian, constraints defined for sets of variables are given. A constraint defined for a set of variables is a condition that is defined separately from the conditions indicated by expression (2). An example of a specific constraint is the constraint that “only one of the variables in the set is 1, and the other variables are −1”. This constraint is sometimes referred to as the One-Hot constraint. In combinatorial optimization problems, the setting in which the solution of expression (2) is obtained given several such constraints is often used. The One-Hot constraint is an example of a constraint.

In the technique described in PTL 4, when selecting a variable (spin) in the process corresponding to Process 2 above, when updating the value of the variable changes the state of the constraint defined for the set to which the variable belongs from being satisfied to not being satisfied, then in order to maintain the state of the constraint being satisfied, in addition to the variable, further variable that is a candidate for updating is selected. In other words, multiple variables are selected simultaneously. As a result, solution search that would no longer satisfy the constraint condition can be omitted. For example, suppose that there is a set of variables for which the above One-Hot constraint is defined, and that the variables belonging to the set satisfy the One-Hot constraint. When only one variable is selected from among those variables and a state transition is accepted, it will always result in a state where the One-Hot constraint is not satisfied. To avoid this, one variable is selected, and then another variable is selected to keep the One-Hot constraint satisfied. Then, a determination is made to accept the state transition of the two variables, and when the state transition is accepted, the states of the two variables are updated simultaneously. As a result, the One-Hot constraint is still satisfied after the state transition. In other words, in Process 3, the amount of change in the evaluation function when all the selected multiple variables are updated is calculated, and in Process 4, it is determined whether or not to accept the update of all the multiple variables. Therefore, the technique described in PTL 4 can transition the state while satisfying the given constraints as much as possible. This enables efficient solution search by avoiding unnecessary solution search that does not satisfy the constraints as much as possible.

### CITATION LIST

### Patent Literature

PTL 1: International Publication WO2019/078354
PTL 2: Japanese Patent Application Laid-Open No. 2018-41351
PTL 3: Japanese Patent Application Laid-Open No. 2019-145010
PTL 4: International Publication WO2021/059338

### Non Patent Literature

NPL 1: A. Lucas, “Ising formulations of many NP problems”, Frontiers in Physics, 2014, Volume 2, Article 5

### SUMMARY OF INVENTION

### Technical Problem

The inventor of the present invention has found a technique for parallelizing the state update of dynamical systems. Hereafter, this technique will be referred to as “technique T” for convenience. In the technique T, a distributed parallel environment is assumed, and the processes are assumed to be distributed. In other words, the devices executing the processes are distributed and each device executes each process. In each distributed process, Processes 2 and 3 are executed independently. That is, variables are selected independently, and the amount of change in the evaluation function, Δ, is also calculated independently. In Process 4, the acceptance of state transitions is determined in the order of process number. At this time, the subsequent process calculates Δ without considering the state transitions accepted by the previous process. Therefore, the value Δ of the amount of change obtained in expression (4) will be different from the original value. However, the subsequent process corrects this value Δ of the amount of change by communicating the number (index) of the variable whose state has been updated in the previous process in line, and then makes a determination on acceptance of the state transition. The calculation of expression (4) in Process 3 is a bottleneck process, but with the technique T found by the inventor, this calculation can be parallelized while the dynamical system can be configured without losing the sequential nature of state updates.

Each process is allocated variables whose values can be updated, and each process can update the values of the allocated variables. However, each process cannot update the value of a variable to which it is not allocated. The elements of the matrix used in the evaluation function (expression (1)), Jᵢⱼ, are held in a memory of each process in a distributed manner. Each process holds element Jᵢⱼ(1≤j≤N) for the set of indices i of the allocated variables. This set of indices is denoted I. The processes (each device executing each process) are connected communicatively in a circular fashion, and each process can communicate with two processes before and after it.

In above techniques T, in each process, the process proceeds as follows.

Process 1′. Each process is given a common initial state.

Process 2′. Randomly select p variables from the set I. p is the number of variables to be processed by one process and is a parameter for efficient processing execution.

Process 3′-1. Let s be the state at this point. Then, let s′ be the state in which one of the p selected variables is multiplied by −1. Since the number of selected variables is p, there are also p s′. Then, for each s′, the calculation of expression (4) is performed to calculate the amount of change Δ from the value of the evaluation function in state s to the value of the evaluation function in state s′. Therefore, the calculation of A is also performed p times.

Process 3′-2. From one previous process, a set of indices of updated variable (let K) is received. The state s″ is the state in which the variables indicated by the indices in the set K are multiplied by −1 from the state s. Then, the difference Δ′ between the value of the evaluation function in state s″ and the value of the evaluation function in state s′ is calculated. The calculation of Δ′ can be simplified by using Δ that has already been calculated. In other words, the calculation can be simplified by calculating Δ′ using the following expression (6).

$$\begin{matrix}[ Math . 6 ] & \\ {Δ}^{′} = H ( {s}^{″} ) - H ( {s}^{′} ) = Δ + 2 {s}_{i}^{″} {\sum }_{j ∈ K} {J}_{ij} {s}_{j}^{″} & ( 6 )\end{matrix}$$

Δ′ is the original value of Δ, reflecting the results of updating the values of the variables performed so far. In other words, expression (6) corrects Δ to its original value.

Process 4. Calculate the acceptance probability of state transition using Δ′ instead of Δ in expression (5), which represents the acceptance probability.

Process 4′-1. Determine acceptance of state transition. When the determination is made to accept the state transition, the value of the variable at index i is updated. In this case, index i is added to the set K.

Process 4′-2. Repeat Process 3′-2 to Process 4′-1 for p variables.

Process 4′-3. Send the set K to the next process on the communication path.

Process 5′. Repeat from Process 2′ to Process 4′-3.

The technique described in PTL 4 cannot simply be applied to the technique T.

In the technique T, variables are allocated to each process. At this time, it is considered that variables that belong to a set of variables for which a constraint is defined are often distributed and allocated to multiple processes. Then, it becomes impossible to realize the technique described in PTL 4. In other words, since there is no guarantee that variables belonging to a set of variables for which a constraint is defined will be allocated collectively to one process, it frequently happens that one process cannot simultaneously select multiple variables belonging to a set of variables for which a constraints is defined, as in the technique described in PTL 4. As a result, the solution search proceeds without many of the given constraints being satisfied.

Therefore, the purpose of the present invention is to provide a variable allocation device, a variable allocation method, and a variable allocation program that can appropriately allocate variables of a combinatorial optimization problem to multiple devices that process in parallel.

### Solution to Problem

A variable allocation device according to the present invention allocates variables of a combinatorial optimization problem to ordered multiple parallel processing means which are allocated the variables of the combinatorial optimization problem, and perform a process of obtaining values of allocated variables in parallel, wherein the variable allocation device includes: variable allocation means for allocating, for each of sets of variables for which a constraint is defined, variables belonging to the set to any one of the parallel processing means, and after allocating all variables to any parallel processing means, converting indices of the variables allocated to parallel processing means according to order of the parallel processing means; and matrix conversion means for converting a matrix used in an evaluation function of the combinatorial optimization problem according to converted indices of the variables.

A variable allocation method according to the present invention is for allocating variables of a combinatorial optimization problem to ordered multiple parallel processing means which are allocated the variables of the combinatorial optimization problem, and perform a process of obtaining values of allocated variables in parallel, wherein the variable allocation method, implemented by a computer, includes: allocating, for each of sets of variables for which a constraint is defined, variables belonging to the set to any one of the parallel processing means, and after allocating all variables to any parallel processing means, converting indices of the variables allocated to parallel processing means according to order of the parallel processing means; and converting a matrix used in an evaluation function of the combinatorial optimization problem according to converted indices of the variables.

A variable allocation program according to the present invention causes a computer to execute allocating variables of a combinatorial optimization problem to ordered multiple parallel processing means which are allocated the variables of the combinatorial optimization problem, and perform a process of obtaining values of allocated variables in parallel, wherein the variable allocation program causes the computer to execute: a variable allocation process of allocating, for each of sets of variables for which a constraint is defined, variables belonging to the set to any one of the parallel processing means, and after allocating all variables to any parallel processing means, converting indices of the variables allocated to parallel processing means according to order of the parallel processing means; and a matrix conversion process of converting a matrix used in an evaluation function of the combinatorial optimization problem according to converted indices of the variables. The present invention may also be a computer-readable recording medium in which the above variable allocation program is recorded.

### Advantageous Effects of Invention

According to the present invention, variables of a combinatorial optimization problem can be appropriately allocated to multiple devices that process in parallel.

### BRIEF DESCRIPTION OF DRAWING

FIG. 1 It depicts a schematic diagram showing a variable allocation device according to the present invention and multiple elements executing a distributed process in the technique T.

FIG. 2 It depicts a block diagram showing an example configuration of the variable allocation device.

FIG. 3 It depicts a flowchart showing an example of the processing flow of the example embodiment of the present invention.

FIG. 4 It depicts a flowchart showing an example of the processing flow of the example embodiment of the present invention.

FIG. 5 It depicts a schematic diagram showing sets of variables sorted in order of priority.

FIG. 6 It depicts a schematic diagram showing variables allocated to dynamical system updating units.

FIG. 7 It depicts a schematic diagram showing converted indices.

FIG. 8 It depicts a block diagram showing an example configuration of one dynamical system updating unit.

FIG. 9 It depicts a flowchart showing an example of the processing flow of the dynamical system updating unit.

FIG. 10 It depicts a flowchart showing an example of the processing flow of the dynamical system updating unit.

FIG. 11 It depicts a schematic block diagram showing an example of computer configuration related to the variable allocation device of the example embodiment of the present invention.

FIG. 12 It depicts a block diagram showing an overview of the variable allocation device of the present invention.

### DESCRIPTION OF EMBODIMENTS

An example embodiment of the present invention is described below with reference to the drawings.

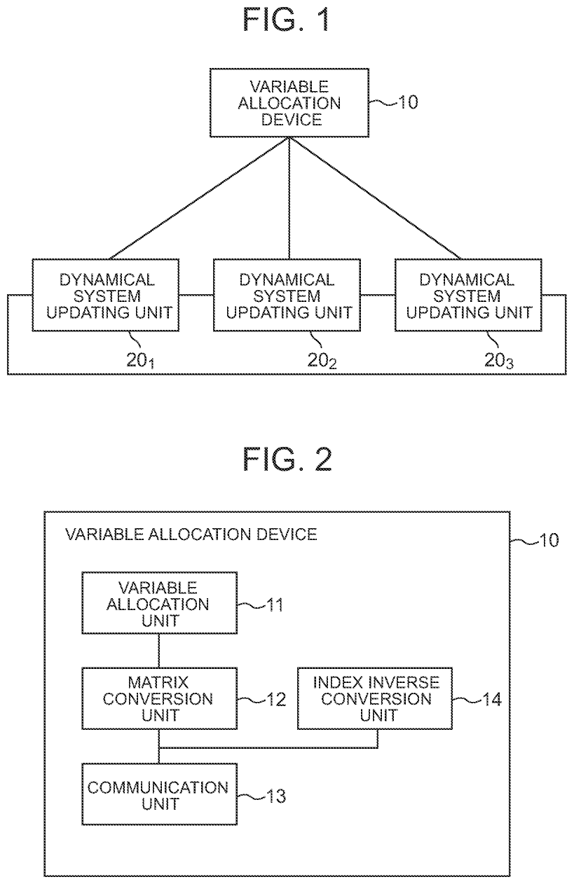

FIG. 1 is a schematic diagram showing a variable allocation device according to the present invention and multiple elements executing a distributed process in the aforementioned technique T.

The dynamical system updating units 20₁-20₃ shown in FIG. 1 are the elements that execute the distributed process in the technique T, respectively. However, the dynamical system updating units 20₁-20₃ execute the distributed process in the technique T by applying the technique described in PTL 4. By the variable allocation device 10 of the example embodiment of the present invention allocating the variables of the combinatorial optimization problem to each of the dynamical system updating units 20₁-20₃, the dynamical system updating units 20₁-20₃ can apply the technique described in PTL 4 to perform the distributed process in the technique T.

When no particular distinction is made between each of the dynamical system updating units 20₁-20₃, the sign 20 without a subscript is used.

Each of the dynamical system updating units 20 may be referred to as a parallel processing means.

Although FIG. 1 shows three dynamical system updating units 20, the number of dynamical system updating units 20 can be multiple and is not limited to three.

Each of the dynamical system updating units 20₁-20₃ are connected in a circular, communicative manner. The multiple dynamical system updating units 20 are then ordered. In the present example embodiment, the subscript of the sign 20 represents the order of the dynamical system updating units 20. Each of the dynamical system updating units 20 can communicate with the previous dynamical system updating units 20 and the next dynamical system updating units 20.

In addition, each of the dynamical system updating units 20 has an upper limit on the number of variables that can be allocated.

In the present example embodiment, the case in which each of the dynamical system updating units 20 is realized by an information processing device (computer) will be used as an example, but each of the dynamical system updating units 20 may be realized by, for example, a processor.

The case in which the variable allocation device 10 is realized by an information processing device (computer) that is different from each dynamical system updating unit 20 will be used as an example.

The variable allocation device 10 is given, in advance, an evaluation function of a combinatorial optimization problem, each variable of the combinatorial optimization problem, a set of variables for which a constraint is defined, and content of the constraint. The set of variables with a constraint is not necessarily one. Each set of variables and the constraints to be satisfied by each set of variables are defined, for example, by the user of the variable allocation device 10 of the present example embodiment.

The variable allocation device 10 is connected to each of the dynamical system updating units 20₁-20₃ for communication. The variable allocation device 10 allocates variables to each of the dynamical system updating units 20₁-20₃ and sends information on the allocated variables to the dynamical system updating units 20 to which they are allocated.

This section describes the types of constraints that can be defined for a set of variables of a combinatorial optimization problem.

(1) One type of constraint on a set of variables is a constraint (One-Hot constraint) in which only one variable is set to “1” among multiple variables belonging to the set and all other variables belonging to the set are set to “−1”. This constraint is hereinafter referred to as the “first constraint”.

(2) Another type of constraint on a set of variables is a constraint that x=y*z in a set consisting of three variables x, y, and z. In this case, x is referred to as the auxiliary spin (the auxiliary variable). This constraint is hereinafter referred to as the “second constraint”. The number of variables belonging to the set for which the second constraint is defined is three.

(3) Constraints other than the first and second constraints are referred to as the third constraints. Examples of the third constraint are, for example, the constraint that at least one variable among multiple variables belonging to a set is set to “1” and the constraint that at least one variable among multiple variables belonging to a set is set to “−1” and the like.

A variable may belong to multiple sets for which a constraint is defined.

In the present example embodiment, priority of the constraints is defined according to the type of constraint. In the present example embodiment, it is assumed that the “first constraint” has the highest priority, the “second constraint” has the second highest priority, and the “third constraint” has the third highest priority.

The priority is determined according to the type of constraint as described above. Furthermore, when the types of constraints are the same, the priority is higher for the set with more variables belonging to the set for which the constraint is defined. For example, in multiple sets for which the “first constraint” is defined, the higher the number of variables that belong to the set, the higher the priority. The same is true for the third constraint. When the number of variables belonging to sets is equal in multiple sets for which the same type of constraint is defined, the priority of those sets may be arbitrarily determined.

Next, the variable allocation device 10 is described. FIG. 2 is a block diagram showing an example configuration of the variable allocation device 10. The variable allocation device 10 includes a variable allocation unit 11, a matrix conversion unit 12, a communication unit 13, and an index inverse conversion unit 14.

The variable allocation unit 11 sorts the sets of variables for which a constraint is defined according to the priority of the constraints. The variable allocation unit 11 selects the sets of variables for which a constraint is defined in order of priority, and for each selected set, allocates the variables belonging to the set to one of the dynamical system updating units 20. At this time, the variable allocation unit 11 allocates the variable belonging to the selected set to the dynamical system updating unit 20 that has the largest difference between the upper limit of the number of variables that can be allocated to the dynamical system updating unit 20 and the number of variables that have already been allocated to the dynamical system updating unit 20.

However, the variable allocation unit 11 may allow the variables belonging to one set to be allocated to multiple dynamical system updating units 20.

After all variables are allocated to any of the dynamical system updating units 20, the variable allocation unit 11 converts the indices of the variables allocated to the dynamical system updating units 20 according to the order of the dynamical system updating units 20. The variable allocation unit 11 converts the indices so that the indices of the variables are in ascending order from 1 according to the order of the dynamical system updating units 20. For example, suppose that three variables with indices of “10”, “16”, and “20” are allocated to the dynamical system updating unit 20₁. In this case, the variable allocation unit 11 converts the indices “10”, “16”, and “20” to indices 1”, “2”, and “3”, respectively. Furthermore, the variable allocation unit 11 converts the index of the variable allocated to the second dynamical system updating unit 20₂ to “4”, “5”, and so on. The variable allocation unit 11 maintains the correspondence between the index before conversion and the index after conversion for each variable.

The matrix conversion unit 12 converts the matrix used in the evaluation function of the combinatorial optimization problem according to the converted indices of the variables.

This conversion will be explained in more detail. The matrix used in the evaluation function of the combinatorial optimization problem has Jᵢⱼ as elements according to two indices i and j. Here, when the number of variables is N, 1≤i≤N and 1≤j≤N. It is assumed that the elements of the matrix after conversion are denoted by J′ with indices as subscripts. Let σ(i) and u(j) denote the post-conversion indices of indices i and j, respectively. In this case, the matrix conversion unit 12 converts each element of the matrix so that the converted J′_{σ(i)σ(j)} is the same as Jᵢⱼ before the conversion. For example, it is assumed that indices “10” and “16” are converted to indices “1” and “2”. In this case, the converted J′_{1,2} is the same as J_{10,16} before conversion. In this way, the matrix conversion unit 12 converts each element of the matrix.

The communication unit 13 sends and receives information to and from each of the dynamical system updating units 20.

The communication unit 13 sends to the individual dynamical system updating unit 20 the converted indices of the allocated variables, the elements of the converted matrix according to the allocated variables, and the constraint defined for the set of allocated variables. The elements of the matrix to be sent are described more specifically. For example, if one of the post-conversion indices of the variables allocated to the dynamical system updating unit 20 is “5”, then the communication unit 13 sends J′_{5,1} to J′_{5,N} to the dynamical system updating unit 20. Depending on the other post-conversion indices, the communication unit 13 sends the elements of the post-conversion matrix to the dynamical system updating unit 20. In other words, if the post-conversion index of the variable allocated to the dynamical system updating unit 20 is σ(i), then the communication unit 13 sends J′_{σ(i),1} to J′_{σ(i),N} to that dynamical system updating unit 20. Here, there are multiple values of σ(i).

The communication unit 13 receives from the individual dynamical system updating unit 20 the value (1 or −1 value) of each variable calculated in the individual dynamical system updating unit 20, together with the index of each variable.

The index inverse conversion unit 14 converts the index of each variable received from the respective dynamical system updating unit 20, together with the value of each variable, back to the index before conversion. In other words, the index inverse conversion unit 14 converts the index of each variable back to the index before conversion.

The communication unit 13 is realized, for example, by a CPU (Central Processing Unit) of a computer operating according to a variable allocation program and a communication interface of the computer. For example, the CPU may read the variable allocation program from a program storage medium such as a program storage device of the computer, and operate as the communication unit 13 using the communication interface according to the variable allocation program. This communication interface is an interface used in communication with each of the dynamical system updating units 20. The variable allocation unit 11, the matrix conversion unit 12, and the index inverse conversion unit 14 are realized, for example, by the CPU of the computer operating according to the variable allocation program. For example, the CPU may read the variable allocation program from the program storage medium as described above and operate as the variable allocation unit 11, the matrix conversion unit 12, and the index inverse conversion unit 14 according to the variable allocation program.

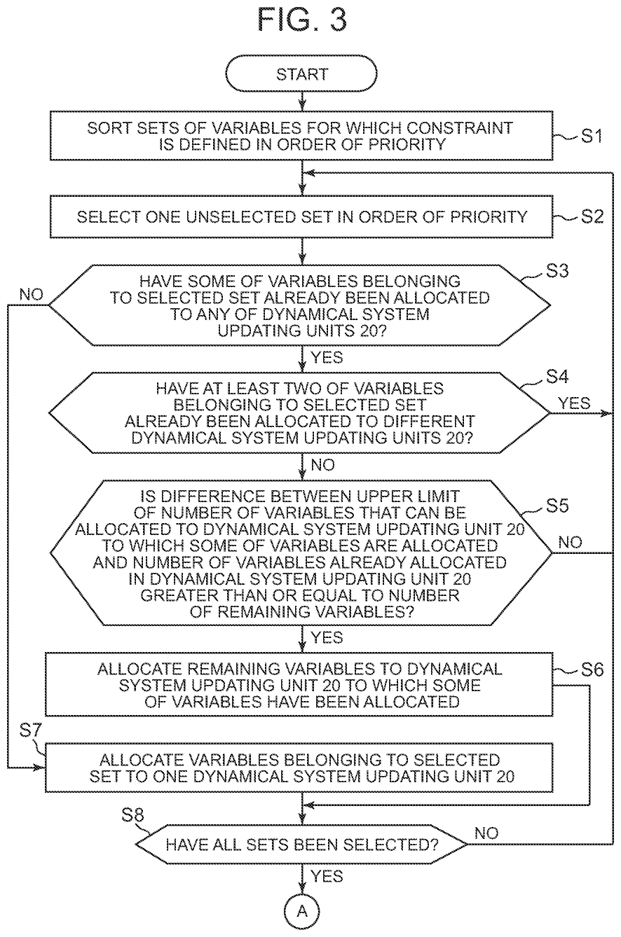

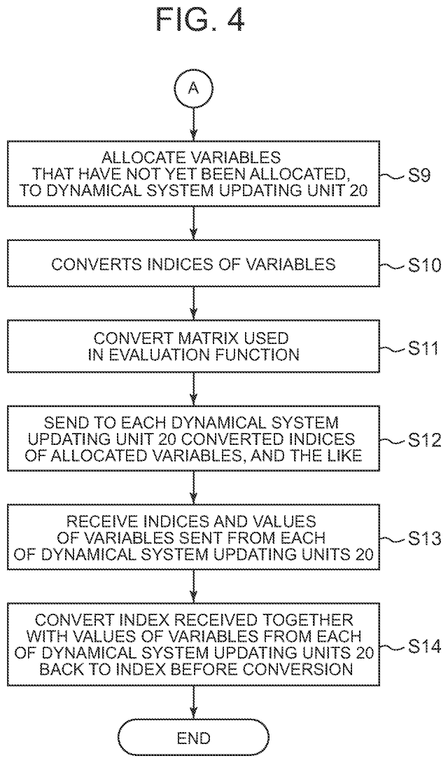

Next, the processing flow will be described. FIG. 3 and FIG. 4 are flowcharts showing an example of the processing flow of the example embodiment of the present invention. For matters already explained, detailed explanations are omitted where appropriate.

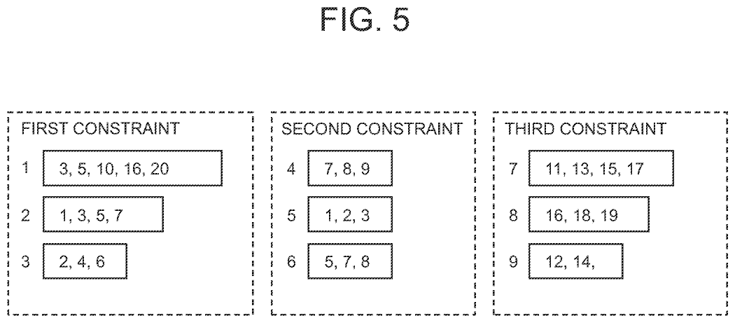

First, the variable allocation unit 11 sorts the sets of variables for which a constraint is defined in order of the priority (step S1). FIG. 5 is a schematic diagram showing sets of variables sorted in order of the priority. As shown in FIG. 5, the priority of the sets for which the first constraint is defined is higher, and among the sets for which the first constraint is defined, the greater the number of variables belonging to the set, the higher the priority. Next, the priority of the sets for which the second constraint is defined is higher. Since the number of variables belonging to the sets for which the second constraint is defined is the same, the priority of the multiple sets for which the second constraint is defined can be arbitrarily determined. Next, the priority of the sets for which the third constraint is defined is higher, and among the sets for which the third constraint is defined, the greater the number of variables belonging to the set, the higher the priority.

Next, the variable allocation unit 11 selects one unselected set (a set of variables with defined constraint) in order of the priority (step S2).

Then, the variable allocation unit 11 determines whether or not some of the variables belonging to the selected set have already been allocated to any of the dynamical system updating units 20 (step S3). When all the variables belonging to the selected set have not been allocated to any of the dynamical system updating units 20 (No in step S3), the process moves to step S7.

In step S7, the variable allocation unit 11 allocates the variables belonging to the selected set to one dynamical system updating unit 20. At this time, the variable allocation unit 11 allocates the variables belonging to the selected set to the dynamical system updating unit 20 with the largest difference between the upper limit of the number of variables that can be allocated to the dynamical system updating unit 20 and the number of variables that have already been allocated to the dynamical system updating unit 20.

When some of the variables belonging to the selected set have already been allocated to one of the dynamical system updating units 20 (Yes in step S3), the process moves to step S4.

In step S4, the variable allocation unit 11 determines whether or not at least two of the variables belonging to the selected set have already been allocated to different dynamical system updating units 20. When at least two variables have been allocated to different dynamical system updating units 20 (Yes in step S4), the process from step S2 onward is repeated. In this case, variables belonging to the above selected set that have not yet been allocated to the dynamical system updating unit 20 are allocated to the dynamical system updating unit 20 in step S9, described below. This means that the variable allocation unit 11 allows variables belonging to the above selected set to be allocated to different dynamical system updating units 20.

When some of the above variables are allocated to only one dynamical system updating unit 20 (No in step S4), step S5 is performed. In step S5, the variable allocation unit 11 determines whether or not the difference between the upper limit of the number of variables that can be allocated to the dynamical system updating unit 20 to which some of the above variables are allocated and the number of variables already allocated in the dynamical system updating unit 20 is greater than or equal to the number of variables other than some of the above variables in the selected set of variables (referred to as “remaining variables”).

When the above difference is less than the number of remaining variables (No in step S5), the process from step S2 onward is repeated. In this case, variables belonging to the above selected set that have not yet been allocated to the dynamical system updating unit 20 are allocated to the dynamical system updating unit 20 in step S9 described below. This means that the variable allocation unit 11 allows variables belonging to the above selected set to be allocated to different dynamical system updating units 20.

When the above difference is greater than or equal to the number of remaining variables (Yes in step S5), the variable allocation unit 11 allocates the remaining variables to the dynamical system updating unit 20 to which some of the above variables have been allocated (step S6).

After step S6 and after step S7, the variable allocation unit 11 determines whether or not all sets (sets of variables for which a constraint is defined) have been selected (step S8). When there are unselected sets (No in step S8), the process is repeated from step S2 onward.

When all sets have been selected (Yes in step S8), the process moves to step S9. The process after step S9 is shown in FIG. 4.

In step S9, the variable allocation unit 11 allocates variables that have not yet been allocated to the dynamical system updating unit 20, to the dynamical system updating unit 20. In step S9, the variable allocation unit 11 preferentially allocates variables to the dynamical system updating unit 20 with the largest difference between the upper limit of the number of variables that can be allocated to the dynamical system updating unit 20 and the number of variables that have already been allocated to the dynamical system updating unit 20.

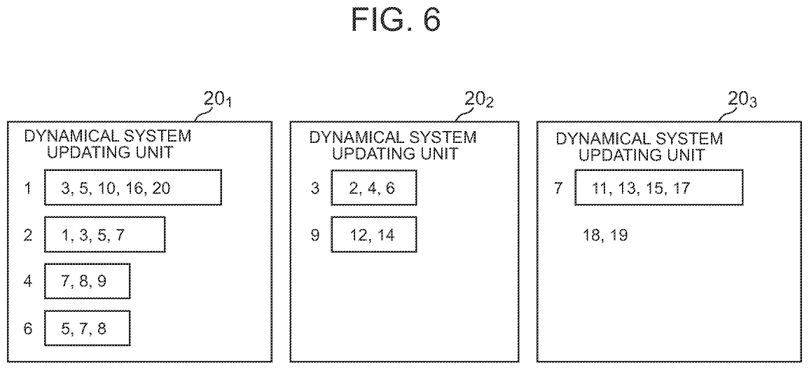

It is assumed that the upper limit on the number of variables that can be allocated in any of the dynamical system updating units 20₁-20₃ is 10. Moreover, it is assumed that the 9 sets shown in FIG. 5 are given. In this case, the variables belonging to each set are allocated to the dynamical system updating unit 20₁-20₃, for example, as shown in FIG. 6, in the process up to step S9 above. In this example, variables belonging to the set with priority “5” shown in FIG. 5 are allocated to different dynamical system updating units 20₁ and 20₂ (see FIG. 5 and FIG. 6). The variables indicated by the indices 18 and 19 belonging to the priority “8” set shown in FIG. 5 are allocated to the dynamical system updating unit 20₃ in step S9.

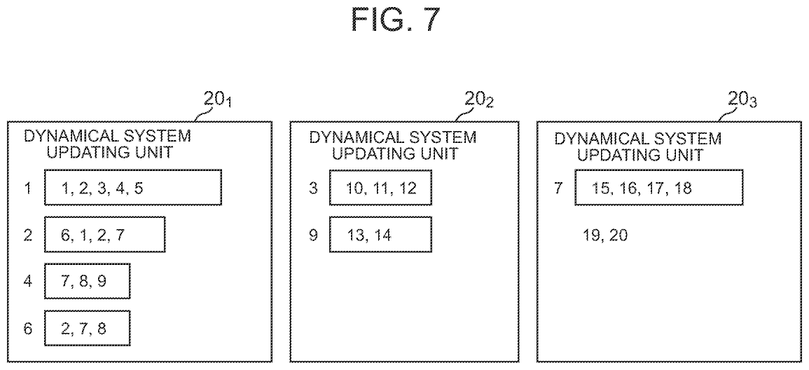

Next, the variable allocation unit 11 converts the indices so that the indices of the variables are in ascending order from 1 according to the order of the dynamical system updating units 20 (step S10). As shown in FIG. 6, it is assumed that the variables indicated by indices 3, 5, 10, 16, 20, 1, 7, 8, and 9 are allocated to the dynamical system updating unit 20₁. Also, it is assumed that the variables indicated by the indices 2, 4, 6, 12, and 14 are allocated to the dynamical system updating unit 20₂. Also, it is assumed that the variables indicated by indices 11, 13, 15, 17, 18, and 19 are allocated to the dynamical system updating unit 20₃. In this case, variable allocation unit 11 converts indices 3, 5, 10, 16, 20, 1, 7, 8, 9 to indices 1, 2, 3, 4, 5, 6, 7, 8, 9. The variable allocation unit 11 also converts indices 2, 4, 6, 12, 14 to indices 10, 11, 12, 13, 14. The variable allocation unit 11 also converts indices 11, 13, 15, 17, 18, 19 to indices 15, 16, 17, 18, 19, 20. The state after the indices are changed in this way is shown in FIG. 7. The variable allocation unit 11 maintains the correspondence between the index before conversion and the index after conversion for each variable.

Next, the matrix conversion unit 12 converts the matrix used in the evaluation function (step S11). As mentioned above, the converted indices of indices i and j are σ(i) and σ(j), respectively. The matrix conversion unit 12 converts each element of the matrix so that the converted J′_{σ(i)σ(j)} is identical to Jᵢⱼ before the conversion.

Next, the communication unit 13 sends to the individual dynamical system updating unit 20 the converted indices of the allocated variables, the elements of the converted matrix according to the allocated variables, and the constraints defined for the sets of allocated variables (step S12).

When allocating variables to each of the dynamical system updating units 20, the communication unit 13 excludes from sending the constraints defined for the sets of variables allocated to different dynamical system updating units 20. For example, in the examples shown in FIG. 5 to FIG. 7, the constraints defined for the sets with priority “5” and priority “8” may be excluded from sending.

When variables are allocated to each of the dynamical system updating units 20, the communication unit 13 may send the constraints defined for the sets of variables that are allocated to different dynamical system updating units 20 to the respective dynamical system updating units 20. For example, in the examples shown in FIG. 5 to FIG. 7, the converted indices 4, 19, and 20 belong to the set with priority “8”, and the variable indicated by the converted index 4 is allocated to the dynamical system updating unit 20₁, and the variables indicated by the converted indices 19 and 20 are allocated to the dynamical system updating unit 20₃. In this case, communication unit 13 may send information to the dynamical system update unit 20₁ indicating that the third constraint is defined for the set including the variable indicated by index 4, and similarly may send information to the dynamical system update unit 20₃ indicating that the third constraint is defined for the set including the variables indicated by indices 18 and 19. However, this technical matter does not apply to the sets for which the second constraint is defined.

Each of the dynamical system updating units 20₁-20₃ that received the information sent in step S12 executes the process of obtaining the values of the allocated variables in parallel and sends the obtained values of the variables and the indices of the variables to the variable allocation device 10. The operation of the dynamical system updating unit 20 is described below.

The variable allocation device 10 receives the indices and values of the variables sent from each of the dynamical system updating units 20 (step S13).

Next, the index inverse conversion unit 14 converts the index received together with the values of the variables from each of the dynamical system updating units 20 back to the index before the conversion (step S14).

This results in a value for each variable indicated by the index before conversion. The value of each variable corresponds to the solution of the combinatorial optimization problem.

A variation of the above processing flow is described here. In the above processing flow, the case is described where at least two of the variables belonging to the selected set have already been allocated to the different dynamical system updating unit 20 (Yes in step S4), and the process moves immediately to step S2. In this case (Yes in step S4), the variable allocation unit 11 may allocate to one of the above different dynamical system updating units 20 variables that have not yet been allocated to the dynamical system updating unit 20 among the variables belonging to the selected set.

For example, it is assumed that the variable allocation unit 11 selects a set with priority “5” as shown in FIG. 5. In this case, the variables indicated by indices 1 and 3 belonging to this set are allocated to the dynamical system updating unit 20₁, and the variable indicated by index 2 belonging to this set is allocated to the dynamical system updating unit 20₂. In this case, the variable allocation unit 11 may allocate to either of the dynamical system updating units 20₁, 20₂ a variable belonging to the selected set that has not yet been allocated to that dynamical system updating unit 20. In this case, the variable allocation unit 11 may select the dynamical system updating unit 20 with the largest difference between the upper limit that can be allocated and the number of variables that have already been allocated as the dynamical system updating unit 20 to which the variables are to be allocated.

However, the following two conditions must be met when the variable allocation unit 11 allocates variables to the selected dynamical system updating unit 20. The first condition is that the number of variables to be allocated from now on must be greater than or equal to the difference between the upper limit that can be allocated and the number of variables that have already been allocated.

The second condition is that when variables are allocated, the number of duplicate variables allocated to multiple dynamical system updating units 20 is less than or equal to the allowable number of duplicates. For example, in the above example, it is assumed that the variable allocation unit 11 allocates variables with indices 1 and 3 to the dynamical system updating unit 20₂. In this case, the variable indicated by index 1 and the variable indicated by index 3 will be allocated to the dynamical system updating units 20₁, 20₂, respectively. In this case, the number of duplicate variables allocated to multiple dynamical system updating units 20 in duplicate is 2. The allowable number of duplicates is a value obtained by subtracting the number of variables of the combinatorial optimization problem from the sum of the upper limit of variables that can be allocated, which is defined for each of the dynamical system updating units 20. In this example, the above sum is 30 and the number of variables is 20, so the allowable number of duplicates is 30-20=10. When the number of duplicate variables allocated to more than one dynamical system updating unit 20 is larger than the allowable number of duplicates, variables that cannot be allocated to any of the dynamical system updating units 20 will be created, so the second condition must also be satisfied.

When both the first and second conditions are satisfied, the variable allocation unit 11 may allocate variables to the selected dynamical system updating unit 20. Thereafter, the operation from step S2 onward is repeated. The above is a description of a variation of the processing flow.

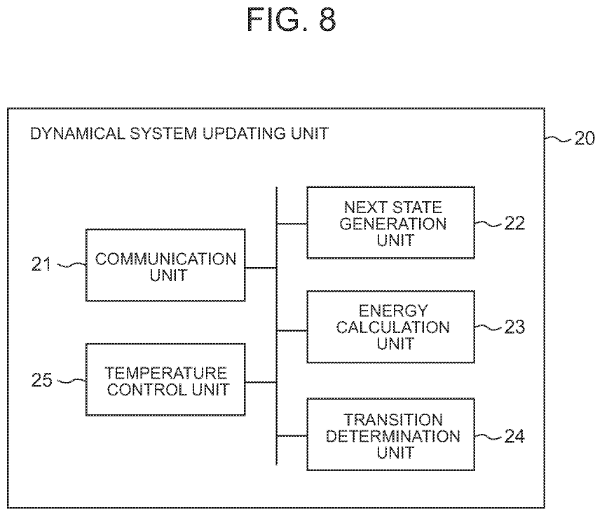

Next, the dynamical system updating unit 20 is described. FIG. 8 is a block diagram showing an example configuration of one dynamical system updating unit 20. The configuration of each dynamical system updating unit 20 is common. The dynamical system updating unit 20 includes a communication unit 21, a next state generation unit 22, an energy calculation unit 23, a transition determination unit 24, and a temperature control unit 25.

The communication unit 21 receives the information sent by the variable allocation device 10 in step S12 (see FIG. 4). That is, the communication unit 21 receives the indices of the variables allocated to the dynamical system updating unit 20, the elements of the matrix after conversion according to the allocated variables, and the constraints defined for the sets of allocated variables.

The communication unit 21 also sends and receives the set K of indices of the updated variables to and from the previous dynamical system updating unit 20 and the next dynamical system updating unit 20.

The next state generation unit 22 generates p next states. A next state is, in principle, a state in which the value of one variable is updated. However, when updating the value of one variable changes the constraint defined for the set to which the variable belongs from satisfied to not satisfied, the next state is the state in which the value of another variable belonging to the set is changed in addition to the one variable so that the constraint is maintained in the satisfied state. However, there is only one set in which another variable is also updated so that the constraint remains in the satisfied state.

However, the only variables whose values can be updated are those allocated to the dynamical system updating unit 20 by the variable allocation device 10.

Let s be the state of each variable at the present time. And let s′ be the individual next state. The energy calculation unit 23 calculates the amount of change Δ in the value of the evaluation function for each next state by the calculation in expression (4). In other words, the energy calculation unit 23 calculates the amount of change Δ for p.

The energy calculation unit 23 modifies the amount of change Δ for each next state when the communication unit 21 receives the set K from the one previous dynamical system updating unit 20. The modified amount of change is denoted as Δ′.

The energy calculation unit 23 calculates the modified amount of change Δ′ by the calculation of expression (7) shown below.

$$\begin{matrix}[ Math . 7 ] & \\ {Δ}^{′} = H ( {s}^{″} ) - H ( {s}^{′} ) = Δ + 2 {s}_{i}^{″} {\sum }_{j ∈ K} {J}_{ij}^{′} {s}_{j}^{″} & ( 7 )\end{matrix}$$

s″ is the variable indicated by the index in the set K multiplied by −1 from state s.

For each next state, the transition determination unit 24 determines whether to accept or reject the state transition to the next state. When the transition determination unit 24 determines that the state transition is accepted, the transition determination unit 24 updates to the next state that it is focusing on. When the transition determination unit 24 determines that the state transition is to be rejected, the transition determination unit 24 does not update to the next state that it is focusing on. In determining whether to accept or reject the state transition, the transition determination unit 24 uses the acceptance probability shown in expression (8).

$$\begin{matrix}[ Math . 8 ] & \\ min ( exp ( - \frac{{Δ}^{′}}{T} ) , 1 ) & ( 8 )\end{matrix}$$

The temperature control unit 25 controls the temperature T. For example, the temperature control unit 25 decreases the temperature T by a predetermined value for each predetermined number of state updates.

The communication unit 21 is realized, for example, by a CPU of a computer operating according to a program and a communication interface of the computer. For example, the CPU may read the program from a program storage medium such as a program storage device of the computer, and operate as the communication unit 21 using the communication interface according to the program. This communication interface is an interface used in communication with the variable allocation device 10 and the adjacent dynamical system updating unit 20. The next state generation unit 22, the energy calculation unit 23, the transition determination unit 24, and the temperature control unit 25 are realized, for example, by the CPU of the computer operating according to the program. For example, the CPU may read the program from the program storage medium as described above and operate as the next state generation unit 22, the energy calculation unit 23, the transition determination unit 24, and the temperature control unit 25 according to the program.

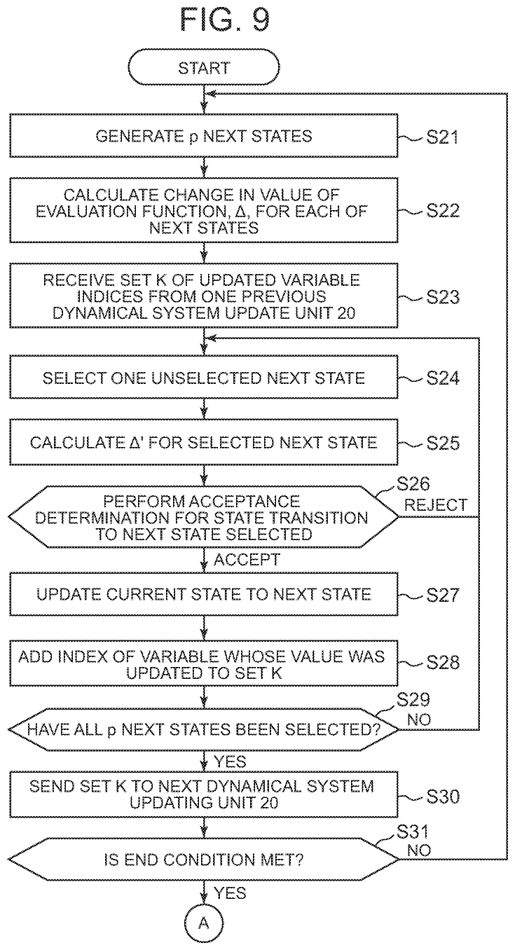

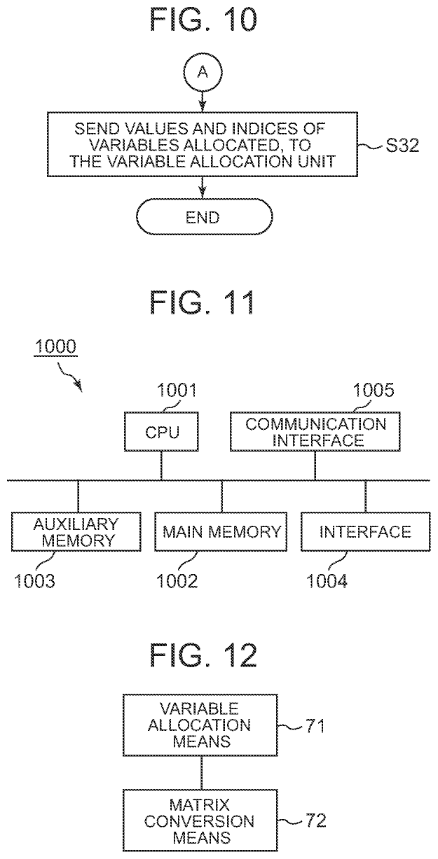

Next, the processing flow of the dynamical system updating unit 20 is described. FIG. 9 and FIG. 10 are flowcharts showing an example of the processing flow of the dynamical system updating unit 20. For matters already explained, detailed explanations are omitted where appropriate. In FIG. 9 and FIG. 10, the operation of the temperature control unit 25 is not shown. It is assumed that the temperature control unit 25 performs an operation to decrease the temperature T by a predetermined value each time the state is updated a predetermined number of times.

It is assumed that each of the respective dynamical system updating units 20 receives the information sent by the variable allocation device 10 in step S12 (see FIG. 4). It is also assumed that each dynamical system updating unit 20 is given a common initial state as the initial state of each variable. The method of giving a common initial state to each dynamical system updating unit 20 is not limited.

First, the next state generation unit 22 generates p next states (step S21). However, the only variables whose values can be updated are those allocated to the dynamical system updating unit 20 by the variable allocation device 10.

Next, the energy calculation unit 23 calculates the change in the value of the evaluation function, A, for each of the next states, respectively, by calculating expression (4) (step S22).

Next, the communication unit 21 receives the set K of updated variable indices from the one previous dynamical system update unit 20 (step S23).

Next, the energy calculation unit 23 selects one unselected next state among the p next states (step S24).

Then, the energy calculation unit 23 calculates Δ′ for the selected next state by the calculation in expression (7) (step S25). In other words, the energy calculation unit 23 modifies Δ to Δ′ for the selected next state, where Δ′ is the original value of A reflecting the results of updating the values of variables performed so far.

Next, the transition determination unit 24 performs an acceptance determination for the state transition to the next state selected in step S24 (step S26). In step S26, the transition determination unit 24 uses the acceptance probability shown in expression (8).

When the state transition to the next state is rejected, the operation from step S24 onward is repeated without updating the state.

When the state transition to the next state is accepted, the transition determination unit 24 updates the current state to the next state selected in step S24 (step S27).

The transition determination unit 24 adds the index of the variable whose value was updated in step S27 to the set K (step S28).

Next, the energy calculation unit 23 determines whether or not all p next states generated in step S21 have been selected (step S29). When there are still some next states that have not been selected (No in step S29), the operation from step S24 onward is repeated.

When all p next states have been selected (Yes in step S29), the communication unit 21 sends the set K to the next dynamical system updating unit 20 (step S30).

Next, the next state generation unit 22 determines whether or not the end condition of the iterative process starting from step S21 is met (step S31). The end condition can be predetermined as the number of iterations starting from step S21 has reached a predetermined number. However, the above example is only one example of an end condition, and end conditions are not limited to the above example.

When the end condition is not met (No in step S31), the process is repeated from step S21 onward.

When the end condition is met, the process moves to step S32. Step S32 is shown in FIG. 10.

In step S32, the communication unit 21 sends the values and indices of the variables allocated to the dynamical system updating unit 20 to the variable allocation unit 10.

Each dynamical system updating unit 20 sends the values and indices of the variables to the variable allocation device 10 in step S32, and the communication unit 13 of the variable allocation device 10 receives the values and indices of the variables in step S13 (see FIG. 4). The variable allocation device 10 then performs operations from step S13 onward.

According to the present example embodiment, for each set of variables for which a constraint is defined, the variable allocation unit 11 of the variable allocation device 10 allocates the variables belonging to the set to any one of dynamical system updating units 20. Therefore, the next state generation unit 22 of the dynamical system updating unit 20 can generate, as the next state, a next state in which multiple variables belonging to the set are updated so as to maintain the state in which the constraint defined for the set of variables is satisfied. Thus, in the multiple dynamical system updating units 20, it is possible to perform a process that applies the technique described in PTL 4 to the technique T.

In other words, the variables of the combinatorial optimization problem can be appropriately allocated to multiple dynamical system updating units 20 that are processed in parallel, so that the techniques described in PTL 4 can be applied to the technique T in the multiple dynamical system updating units 20.

FIG. 11 is a schematic block diagram showing an example of computer configuration related to the variable allocation device 10 of the example embodiment of the present invention. The computer 1000 includes a CPU 1001, a main memory 1002, an auxiliary memory 1003, an interface 1004, and a communication interface 1005.

The variable allocation device 10 of the example embodiment of the present invention is realized, for example, by the computer 1000. The operation of the variable allocation device 10 is stored in the auxiliary memory 1003 in the form of a variable allocation program. The CPU 1001 reads the program, expands the program in the main memory 1002, and executes the processing of the variable allocation device 10 described in the example embodiment of the present invention according to the program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc. When the variable allocation program is delivered to the computer 1000 through a communication line, the computer 1000 receiving the delivery may expand the program into the main memory 1002 and execute the processes of the variable allocation device 10 described in the above example embodiment according to the program.

Some or all of the components of the variable allocation device 10 may be realized by general-purpose or dedicated circuits (circuitry), processors, or a combination of these. They may be configured by a single chip or by multiple chips connected via a bus. A part or all of each component may be realized by a combination of the above-mentioned circuits, etc. and a program.

These points also apply to the dynamical system updating unit 20.

The following is an overview of the present invention. FIG. 12 is a block diagram showing an overview of the variable allocation device of the present invention. The variable allocation device of the present invention allocates variables of a combinatorial optimization problem to ordered multiple parallel processing means (e.g., multiple dynamical system updating units 20) which are allocated the variables of the combinatorial optimization problem, and perform a process of obtaining values of allocated variables in parallel. The variable allocation device includes variable allocation means 71 and matrix conversion means 72.

The variable allocation means 71 (e.g., the variable allocation unit 11) allocates, for each of sets of variables for which a constraint is defined, variables belonging to the set to any one of the parallel processing means, and after allocating all variables to any parallel processing means, converts indices of the variables allocated to parallel processing means according to order of the parallel processing means.

The matrix conversion means 72 (e.g., the matrix conversion unit 12) converts a matrix used in an evaluation function of the combinatorial optimization problem according to converted indices of the variables.

According to such a configuration, variables of a combinatorial optimization problem can be appropriately allocated to multiple devices that process in parallel.

The variable allocation device may be configured to include index inverse conversion means (e.g., the index inverse conversion unit 14) for, when the values of allocated variables are returned from the individual parallel processing means, converting index of each variable back to index before conversion.

Constraints defined for sets of variables may have predefined priority on the type of the constraints, and the variable allocation means 71 may allocate the variables belonging to the set of the variables for which the constraint is defined to any one of the parallel processing means according to the priority of the constraints.

The variable allocation means 71 may allocate the variables belonging to the set of the variables for which the constraint is defined, to the parallel processing means with the largest difference between upper limit of number of variables that can be allocated to the parallel processing means which is defined for the parallel processing means and number of variables which have already been allocated to the parallel processing means.

The variable allocation means 71, when at least two variables among the variables belonging to the set of the variables for which the constraint is defined have already been allocated to different parallel processing means, may allow the variables belonging to the set to be allocated to different parallel processing means.

When some of the variables belonging to the set of the variables for which the constraint is defined have already been allocated to only one parallel processing means, and when difference between upper limit of number of variables that can be allocated to the parallel processing means which is defined for the parallel processing means and number of variables which have already been allocated to the parallel processing means is greater than or equal to the number of variables other than some of the variables belonging to the set, the variable allocation means may allocate the variables other than some of the variables belonging to the set to the parallel processing means.
when some of the variables belonging to the set of the variables for which the constraint is defined have already been allocated to only one parallel processing means, and when difference between upper limit of number of variables that can be allocated to the parallel processing means which is defined for the parallel processing means and number of variables which have already been allocated to the parallel processing means is less than the number of variables other than some of the variables belonging to the set, the variable allocation means may allow the variables belonging to the set to be allocated to different parallel processing means.

Although the present invention has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The present invention is suitably applied to a variable allocation device that allocates variables of a combinatorial optimization problem to multiple devices that process in parallel.

### REFERENCE SIGNS LIST

10 Variable allocation device
11 Variable allocation unit
12 Matrix conversion unit
13 Communication unit
14 Index inverse conversion unit
20 Dynamical system updating unit

What is claimed is:

1. A variable allocation device for allocating variables of a combinatorial optimization problem to ordered multiple parallel processing devices which are allocated the variables of the combinatorial optimization problem, and perform a process of obtaining values of allocated variables in parallel,
wherein the variable allocation device comprises:
a memory configured to store instructions; and
a processor configured to execute the instructions to:
allocate, for each of sets of variables for which a constraint is defined, variables belonging to the set to any one of the parallel processing devices, and after allocating all variables to any parallel processing devices, convert indices of the variables allocated to parallel processing devices according to order of the parallel processing devices; and
convert a matrix used in an evaluation function of the combinatorial optimization problem according to converted indices of the variables.

2. The variable allocation device according to claim 1,
wherein the processor, when the values of allocated variables are returned from the individual parallel processing devices, converts index of each variable back to index before conversion.

3. The variable allocation device according to claim 1,
wherein constraints defined for sets of variables have predefined priority on the type of the constraints, and
wherein the processor allocates the variables belonging to the set of the variables for which the constraint is defined to any one of the parallel processing devices according to the priority of the constraints.

4. The variable allocation device according to claim 1,
wherein the processor allocates the variables belonging to the set of the variables for which the constraint is defined, to the parallel processing device with the largest difference between upper limit of number of variables that can be allocated to the parallel processing device which is defined for the parallel processing device and number of variables which have already been allocated to the parallel processing device.

5. The variable allocation device according to claim 1,
wherein the processor, when at least two variables among the variables belonging to the set of the variables for which the constraint is defined have already been allocated to different parallel processing devices, allows the variables belonging to the set to be allocated to different parallel processing devices.

6. The variable allocation device according to claim 1,
wherein when some of the variables belonging to the set of the variables for which the constraint is defined have already been allocated to only one parallel processing device, and when difference between upper limit of number of variables that can be allocated to the parallel processing device which is defined for the parallel processing device and number of variables which have already been allocated to the parallel processing device is greater than or equal to the number of variables other than some of the variables belonging to the set, the processor allocates the variables other than some of the variables belonging to the set to the parallel processing device.

7. The variable allocation device according to claim 1,
wherein when some of the variables belonging to the set of the variables for which the constraint is defined have already been allocated to only one parallel processing device, and when difference between upper limit of number of variables that can be allocated to the parallel processing device which is defined for the parallel processing device and number of variables which have already been allocated to the parallel processing device is less than the number of variables other than some of the variables belonging to the set, the processor allows the variables belonging to the set to be allocated to different parallel processing devices.

8. A variable allocation method for allocating variables of a combinatorial optimization problem to ordered multiple parallel processing devices which are allocated the variables of the combinatorial optimization problem, and perform a process of obtaining values of allocated variables in parallel,
wherein the variable allocation method, implemented by a computer, comprises:
allocating, for each of sets of variables for which a constraint is defined, variables belonging to the set to any one of the parallel processing devices, and after allocating all variables to any parallel processing devices, converting indices of the variables allocated to parallel processing devices according to order of the parallel processing devices; and
converting a matrix used in an evaluation function of the combinatorial optimization problem according to converted indices of the variables.

9. A non-transitory computer-readable recording medium in which a variable allocation program is recorded, wherein the variable allocation program causes a computer to execute allocating variables of a combinatorial optimization problem to ordered multiple parallel processing devices which are allocated the variables of the combinatorial optimization problem, and perform a process of obtaining values of allocated variables in parallel,
wherein the variable allocation program causes the computer to execute:
a variable allocation process of allocating, for each of sets of variables for which a constraint is defined, variables belonging to the set to any one of the parallel processing devices, and after allocating all variables to any parallel processing devices, converting indices of the variables allocated to parallel processing devices according to order of the parallel processing devices; and
a matrix conversion process of converting a matrix used in an evaluation function of the combinatorial optimization problem according to converted indices of the variables.
